(19) United States
(12) Patent Application Publication
(10) Pub. No.: US 2023/0034552 A1
(43) Pub. Date: Feb. 2, 2023

(54) SIMULATION METHOD AND APPARATUS, COMPUTER DEVICE AND STORAGE MEDIUM

(71) Applicant: CHANGXIN MEMORY TECHNOLOGIES, INC., Hefei City (CN)

(72) Inventor: Xiangqian JIANG, Hefei City (CN)

(21) Appl. No.: 17/655,612

(22) Filed: Mar. 21, 2022

(30) Foreign Application Priority Data
Jul. 28, 2021 (CN) 202110858277.8

(51) Int. Cl. G06F 30/3308

(52) U.S. Cl. CPC G06F 30/3308; G06F 2119/22

(57) ABSTRACT

The present application relates to a simulation method and apparatus, a computer device and a storage medium. The method includes: acquiring RDC data and historical test data of products, the RDC data including repair schemes; allocating the repair schemes to failure cells in the historical test data according to a preset RA, and acquiring a corresponding simulation repair result; and obtaining a yield of the products based on the simulation repair result and the historical test data.

### CROSS-REFERENCE TO RELATED APPLICATION

This application claims the priority of Chinese Patent Application No. 202110858277.8, submitted to the Chinese Intellectual Property Office on Jul. 28, 2021, the disclosure of which is incorporated herein in its entirety by reference.

### TECHNICAL FIELD

The present application relates to the technical field of integrated circuits, and in particular, to a simulation method and apparatus, a computer device and a storage medium.

### BACKGROUND

Integrated circuit chips generally follow a process of design, production, test and verification. Design defects are detected by designers through simulation, while influences of design processes on a yield of semiconductor products are detected by testers through test and verification on the semiconductor products.

However, conventional methods depending on the testers to detect the design defects are time-consuming, causing a waste of production and test costs and prolonging a design update cycle of the semiconductor products.

### SUMMARY

According to an aspect of the present application, a simulation method is provided, including:

acquiring redundancy design configuration (RDC) data and historical test data of products, the RDC data including repair schemes;

allocating the repair schemes to failure cells in the historical test data according to a preset repair algorithm (RA), and acquiring a corresponding simulation repair result; and

obtaining a yield of the products based on the simulation repair result and the historical test data.

According to another aspect of the present application, a simulation apparatus is provided, including: one or more processors; and

a storage apparatus, configured to store one or more programs, wherein the one or more programs, when executed by the one or more processors, cause the one or more processors to execute operations of: acquiring RDC data and historical test data of products, the RDC data including repair schemes; allocating the repair schemes to failure cells in the historical test data according to a preset RA, and acquiring a corresponding simulation repair result; and obtaining a yield of the products based on the simulation repair result and the historical test data.

According to still another aspect of the present application, a computer-readable storage medium is provided. The computer-readable storage medium stores a computer program, and the computer program is executed by a processor to implement steps of the method according to any one of the above-mentioned embodiments.

### BRIEF DESCRIPTION OF THE DRAWINGS

To describe the technical solutions in the embodiments of the present application more clearly, the accompanying drawings required to describe the embodiments are briefly described below. Apparently, the accompanying drawings described below are only some embodiments of the present application. Those of ordinary skill in the art may further obtain accompanying drawings of other embodiments based on these accompanying drawings without creative efforts.

FIG. 1 is a flowchart of a simulation method according to a first embodiment of the present application;

FIG. 2 is a flowchart of a simulation method according to a second embodiment of the present application;

FIG. 3 is a flowchart of a simulation method according to a third embodiment of the present application;

FIG. 4 is a flowchart of a simulation method according to a fourth embodiment of the present application;

FIG. 5 is a schematic implementation diagram of a repair rule within a preset repair range according to an embodiment of the present application;

FIG. 6 is a flowchart of a simulation method according to a fifth embodiment of the present application;

FIG. 7 is a schematic implementation diagram of a repair scheme within a partial repair range according to an embodiment of the present application;

FIG. 8A-FIG. 8E are respectively schematic implementation diagrams of repair schemes within a partial repair range according to different embodiments of the present application;

FIG. 9 is a schematic chart of simulation yields obtained according to repair schemes in FIG. 8A-FIG. 8E;

FIG. 10 is a schematic structural diagram of a simulation apparatus according to an embodiment of the present application; FIG. 11 is a schematic structural diagram of a simulation apparatus according to another embodiment of the present application;

FIG. 12 is a schematic structural diagram of a simulation apparatus according to still another embodiment of the present application; and

FIG. 13 is a schematic structural diagram of a simulation apparatus according to yet another embodiment of the present application.

FIG. 14 is a block diagram of a semiconductor production device according to an exemplary embodiment.

### DETAILED DESCRIPTION

To facilitate the understanding of the present application, the present application is described more completely below with reference to the accompanying drawings. The preferred embodiments of the present application are shown in the accompanying drawings. However, the present application may be embodied in various forms without being limited to the embodiments described herein. On the contrary, these embodiments are provided to make the present application more thorough and comprehensive.

Unless otherwise defined, all technical and scientific terms used herein have the same meaning as commonly understood by those skilled in the technical field of the present application. The terms mentioned herein are merely for the purpose of describing specific embodiments, rather than to limit the present application.

It should be understood that when an element or layer is described as “being on”, “being adjacent to”, “being connected to” or “being coupled to” another element or layer, it can be on, adjacent to, connected to, or coupled to the another element or layer directly, or intervening elements or layers may be present. On the contrary, when an element is described as “being directly on”, “being directly adjacent to”, “being directly connected to” or “being directly coupled to” another element or layer, there are no intervening elements or layers. It should be understood that although terms such as first, second, and third may be used to describe various elements, components, regions, layers, doped types and/or sections, these elements, components, regions, layers, doped types and/or sections should not be limited by these terms. These terms are only used to distinguish one element, component, region, layer, doped type or section from another element, component, region, layer, doped type or section. Thus, a first element, component, region, layer, doped type or section discussed below may be termed a second element, component, region, layer or section without departing from the teachings of the present application. For example, the first doped type may become the second doped type; and similarly, the second dope type may become the first doped type. The first doped type and the second doped type are different doped types.

Spatial relationship terms such as “under”, “beneath”, “lower”, “below”, “above”, and “upper” can be used herein to conveniently describe the relationship shown in the figure between one element or feature and another element or feature. It should be understood that in addition to the orientations shown in the figure, the spatial relationship terms are intended to further include different orientations of used and operated devices. For example, if a device in the accompanying drawings is turned over, and then described as being “beneath another element”, “below it”, or “under it”, the device or feature is oriented “on” the another element or feature. Therefore, the exemplary terms “beneath” and “under” may include two orientations of above and below. In addition, the device may be otherwise oriented (rotated by 90 degrees or other orientations), and the spatial description used herein is interpreted accordingly.

In this specification, the singular forms of “a”, “an” and “the/this” may also include plural forms, unless clearly indicated otherwise. It should also be understood that terms “include” and/or “comprise”, when used in this specification, determine the presence of features, integers, steps, operations, elements and/or components, but do not exclude the presence or addition of one or more other features, integers, steps, operations, elements, components and/or groups. In this specification, the term “and/or” includes any and all combinations of related listed items.

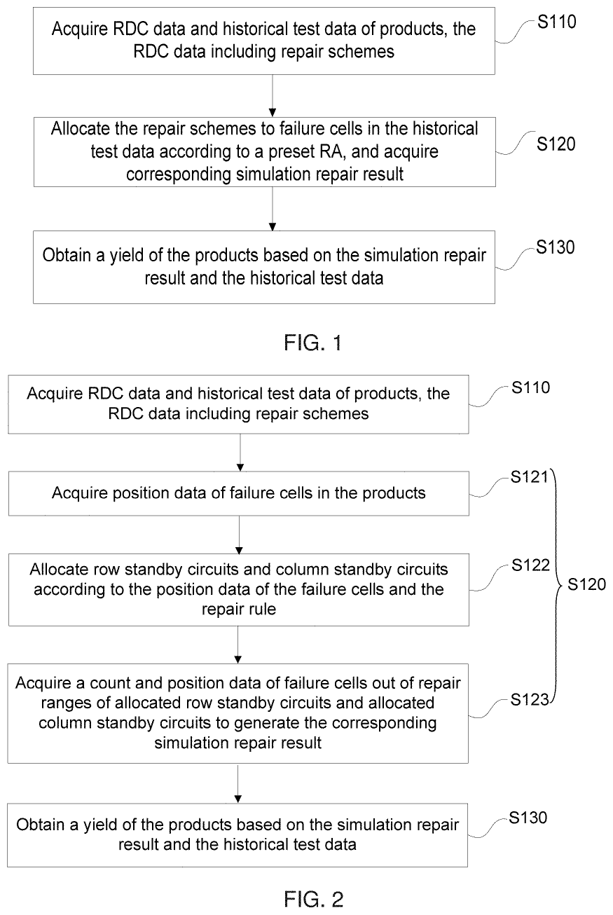

Referring to FIG. 1, the present application provides a simulation method, including the following steps:

Step S110: Acquire RDC data and historical test data of products, the RDC data including repair schemes.

Step S120: Allocate the repair schemes to failure cells in the historical test data according to a preset RA, and acquire a corresponding simulation repair result.

Step S130: Obtain a yield of the products based on the simulation repair result and the historical test data.

The simulation method in the embodiment allocates the repair schemes from the acquired RDC data to the failure cells in the acquired historical test data according to the preset RA, acquires the corresponding simulation repair result, and obtains the yield of the products based on the simulation repair result and the historical test data. By obtaining the simulation yield of the semiconductor products with the present design before production of the semiconductor products, the simulation method is helpful for the designer to detect early defects in the design and improve the design, avoids the waste of production and test costs due to the defective design being put into production, and fully utilizes the historical test data to greatly shorten the design update cycle.

As an example, before Step S110, the simulation method further includes: obtain a duration, the historical test data being test data within the duration, so as to obtain historical test data in a design cycle. By obtaining the simulation yield of the semiconductor products with the present design according to historical test data of a previous adjacent design cycle to the present design cycle, the simulation method is helpful for the designer to detect early defects in the design and improve the design, avoids the waste of production and test costs due to the defective design being put into production, and fully utilizes the historical test data to greatly shorten the design update cycle.

As an example, with simulation of chips as an example, the simulation method further includes: store a TCC, a TUCC and the simulation yield of the products, so as to obtain historical test data in a present design cycle.

As an example, referring to FIG. 2, the repair schemes each include a count of allocable row standby circuits and corresponding position data as well as a count of allocable column standby circuits and corresponding position data in a preset subregion; the preset RA includes a repair rule; and Step S120 includes:

Step S121: Acquire position data of the failure cells in the products.

Step S122: Allocate row standby circuits and column standby circuits according to the position data of the failure cells and the repair rule.

Step S123: Acquire a count and position data of failure cells out of repair ranges of allocated row standby circuits and allocated column standby circuits to generate the corresponding simulation repair result.

As an example, an extension direction of each of the row standby circuits is consistent with that of a WL; and an extension direction of each of the column standby circuits is consistent with that of a BL. For example, a bank may be divided into multiple regions. The ranges of one region include: a length range can be allocated to repair by one row standby circuit in a longitudinal direction such as an WL direction, and a length range can be allocated to repair by one column standby circuit in a transverse direction such as a BL direction. One region may further be subdivided into multiple subregions.

The ranges of one subregions include the length range can be allocated to repair by one row standby circuit in the transverse direction such as the BL direction, but the range in the longitudinal direction such as the WL direction may be specifically defined according to product requirements.

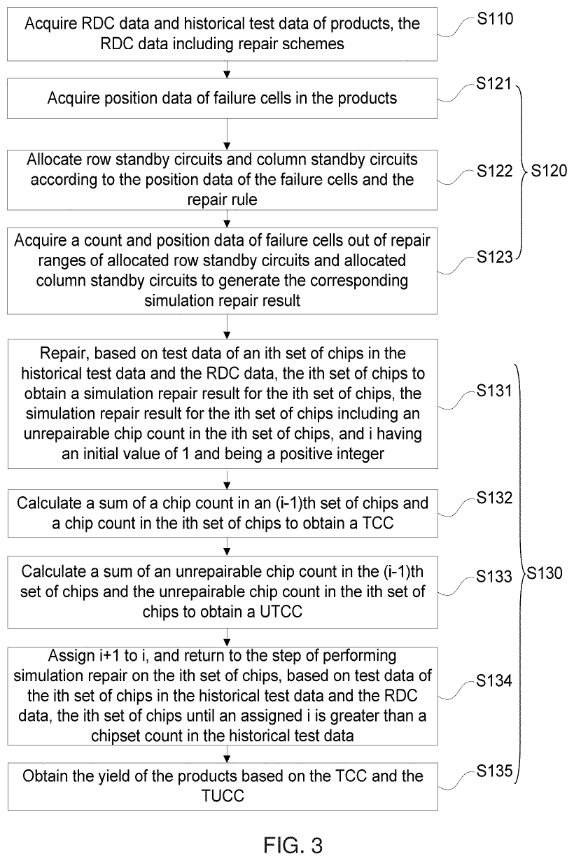

As an example, referring to FIG. 3, Step S130 includes:

Step S131: Repair, based on test data of an ith set of chips in the historical test data and the RDC data, the ith set of chips to obtain a simulation repair result for the ith set of chips, the simulation repair result for the ith set of chips including an unrepairable chip count in the ith set of chips, and i having an initial value of 1 and being a positive integer.

Step S132: Calculate a sum of a chip count in an (i−1)th set of chips and a chip count in the ith set of chips to obtain a TCC.

Step S133: Calculate a sum of an unrepairable chip count in the (i−1)th set of chips and the unrepairable chip count in the ith set of chips to obtain a UTCC.

Step S134: Assign i+1 to i, and return to the step of repairing, based on test data of an ith set of chips in the historical test data and the RDC data, the ith set of chips until an assigned i is greater than a chipset count in the historical test data.

Step S135: Obtain the yield of the products based on the TCC and the TUCC.

It can be set that the simulation repair result for the ith set of chips may further include sizes of chips in the ith set of chips. Based on yields of the products in various RDC data, RDC data meeting requirements in the various RDC data are obtained; or based on yields of the products in various RDC data and the sizes of the chips, RDC data meeting requirements in the various RDC data are obtained.

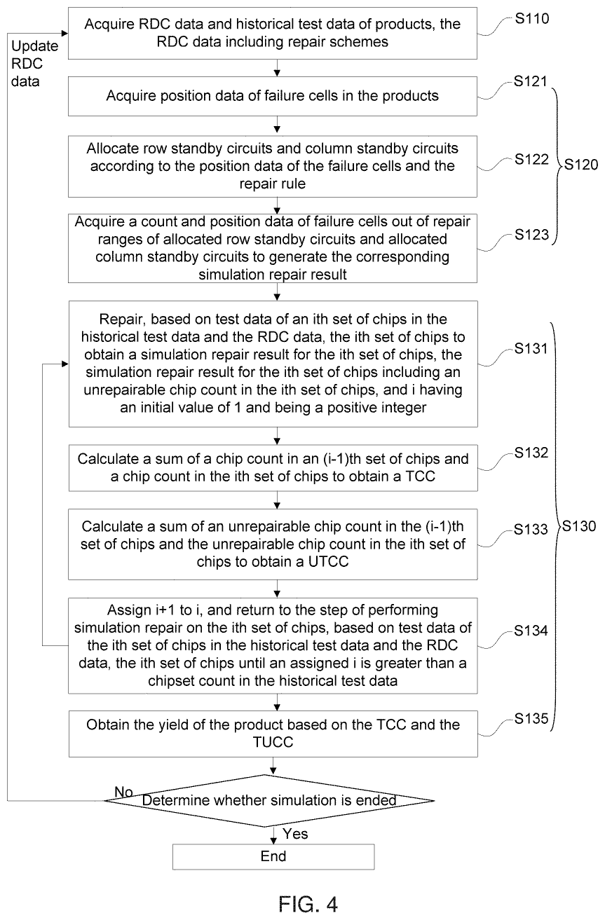

As an example, referring to FIG. 4, after Step S135, the simulation method further includes:

Determine whether simulation is ended.

Acquire, if no, updated RDC data, and obtain a yield of the products under new RDC data based on the updated RDC data and the historical test data.

Specifically, a case where a computer device executes steps of the method in the embodiment is used to exemplarily describe implementation principles of the present application. Upon receiving a simulation count of products (such as DBRMA) and RDC data including repair schemes, the computer allocates the repair schemes to failure cells in historical test data of the products according to a repair rule in a preset RA, acquires a corresponding simulation repair result, and obtains a yield of the products based on the simulation repair result and the acquired historical test data. With the chip products as an example, historical test data of chips are acquired in each simulation procedure, including but not limited to repair range information, subregion information, address information and the like of the failure cells. Steps of the simulation method in the embodiment of the present application are executed on all chips in the simulation products, and the simulation ends after the yields of all chips are obtained. In order to obtain RDC data meeting requirements on the yields of chips, after the simulation is performed on all chips and the yields of all chips are obtained, RDC data may be changed, such that the execution main body of the simulation method, such as the computer, acquires updated RDC data, and obtains yields of the products under new RDC data based on the updated RDC data and the historical test data. Therefore, the simulation yields of the chips under different RDC data are obtained, and the RDC data corresponding to the satisfactory yield are selected, thereby determining the repair schemes finally applied to the products and meeting the requirements on the yield of the products. For example, when the yield of the products in simulation is greater than or equal to a threshold, it can be determined that the products meet the requirements, and the repair schemes in the corresponding RDC data are feasible and can be used in the actual products. Otherwise, the relevant engineer can modify the design scheme to update the RDC data, and obtain the yield of the products under new RDC data based on updated RDC data and the historical test data. Therefore, the simulation method avoids the waste of production and test costs due to the defective design being put into production, and fully utilizes the historical test data to greatly shorten the design update cycle.

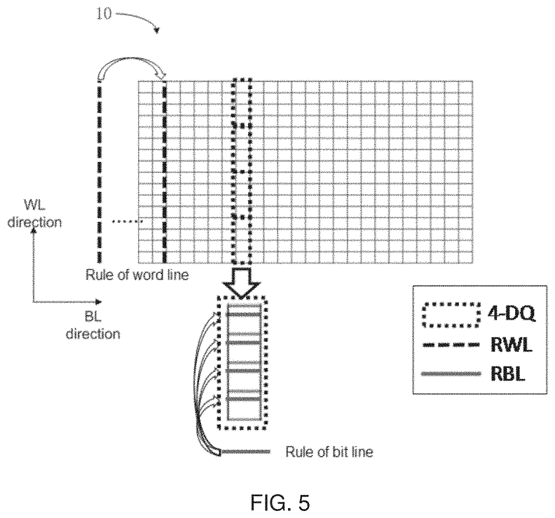

As an example, referring to FIG. 5, the bank shown in FIG. 5 is used as a preset repair range 10. The WL and BL respectively represent longitudinal and transverse continuous memory cells in the figure. The WL length shows continuous digits for a longitudinal continuous 16-bit data queue (DQ), and the BL length shows continuous digits for a transverse single-bit DQ. One DQ may be a die composed of multiple digits.

The repair schemes each include a count of allocable row standby circuits and corresponding position data as well as a count of allocable column standby circuits and corresponding position data in a preset subregion. A standby circuit allocation and repair rule may include a rule of word line and a rule of bit line The rule of word line includes: a first preset count of column standby circuits in the repair range 10. The column standby circuits each can be allocated to repair any WL within the repair range 10. The rule of bit line includes: a second preset count of row standby circuits in the repair range 10. The row standby circuits each can be allocated to repair longitudinal 4-DQ (four continuous DQs) within the preset repair range 10, and repair any BL within the 4-DQ coverage range rather than the memory cell out of the 4-DQ coverage range.

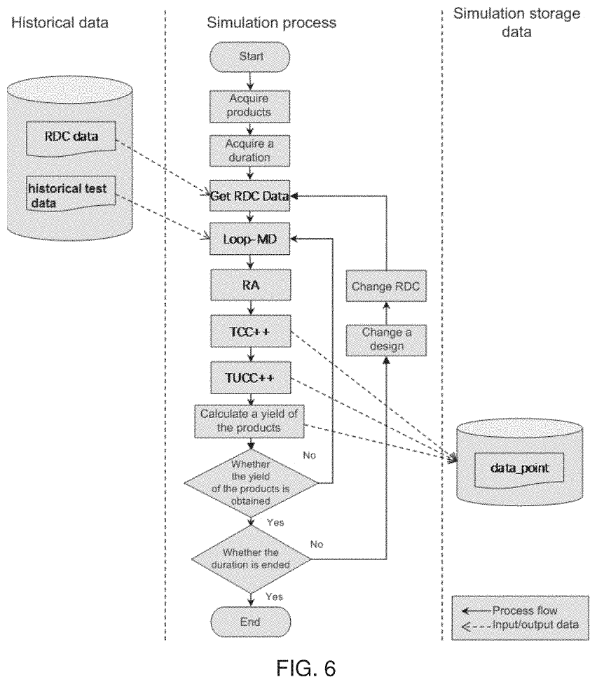

As an example, referring to FIG. 6, the simulation of chip products is used as an example to exemplarily describe the implementation principles of the present application. A duration is acquired to obtain test data within the duration to serve as historical test data, the historical test data including repair range information, subregion information and address information of failure cells. RDC data, the historical test data and the duration of the products are obtained, the RDC data including repair schemes. The repair schemes are allocated to the failure cells in the historical test data according to a preset RA, position data of the failure cells in the products are acquired, row standby circuits and column standby circuits are allocated according to the position data of the failure cells and the repair rule, and a count and position data of failure cells out of repair ranges of allocated row standby circuits and allocated column standby circuits are acquired to generate a corresponding simulation repair result. The repair rule may include the rule of word line and the rule of bit line described above. Loop simulation is performed until all chipsets in the historical test data are traversed (Loop-MD), and the preset RA is executed to allocate the repair schemes to the failure cells in the historical test data. For example, based on test data of an ith set of chips in the historical test data and the RDC data, the ith set of chips are repaired to obtain a simulation repair result for the ith set of chips, the simulation repair result for the ith set of chips including an unrepairable chip count in the ith set of chips, and i having an initial value of 1 and being a positive integer. A sum of a chip count in an (i−1)th set of chips and a chip count in the ith set of chips is calculated to obtain a TCC. A sum of an unrepairable chip count in the (i−1)th set of chips and the unrepairable chip count in the ith set of chips is calculated to obtain a UTCC. i+1 is assigned to i, and the step of performing simulation repair on the ith set of chips, based on test data of an ith set of chips in the historical test data and the RDC data, is returned until an assigned i is greater than a chipset count in the historical test data. The yield of the products is obtained based on the TCC and the TUCC. When the loop simulation is performed and the preset RA is executed to allocate the repair schemes to the failure cells in the historical test data, the TCC++, the TUCC++, and the yield of the products are stored to a preset memory space (data_point). When a yield of the products is greater than or equal to a threshold, the products meet the requirements. Otherwise, if the yield of the products is less than the threshold, the RDC data may be changed, such that the execution main body of the simulation method, such as the computer, acquires updated RDC data, and obtains a yield of the products under new RDC data based on the updated RDC data and the historical test data. Further, based on yields of the products in various RDC data, RDC data meeting requirements in the various RDC data are obtained; or based on yields of the products in various RDC data and the sizes of the chips, RDC data meeting requirements in the various RDC data are obtained. Therefore, by obtaining the simulation yield of the semiconductor products with the present design before production of the semiconductor products, the simulation method in the embodiment is helpful for the designer to detect early defects in the design and improve the design, avoids the waste of production and test costs due to the defective design being put into production, and fully utilizes the historical test data to greatly shorten the design update cycle.

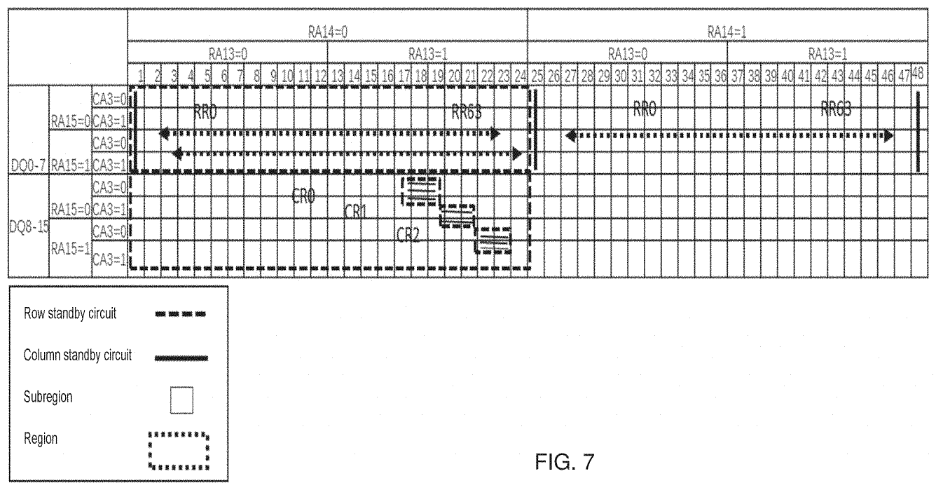

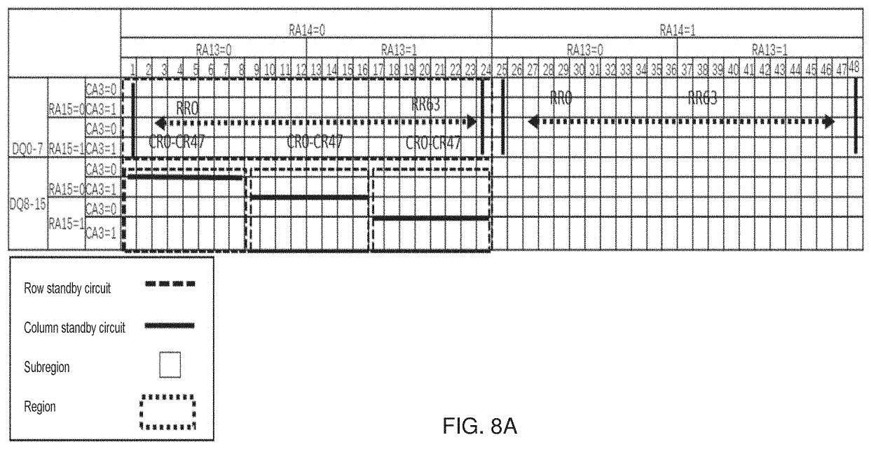

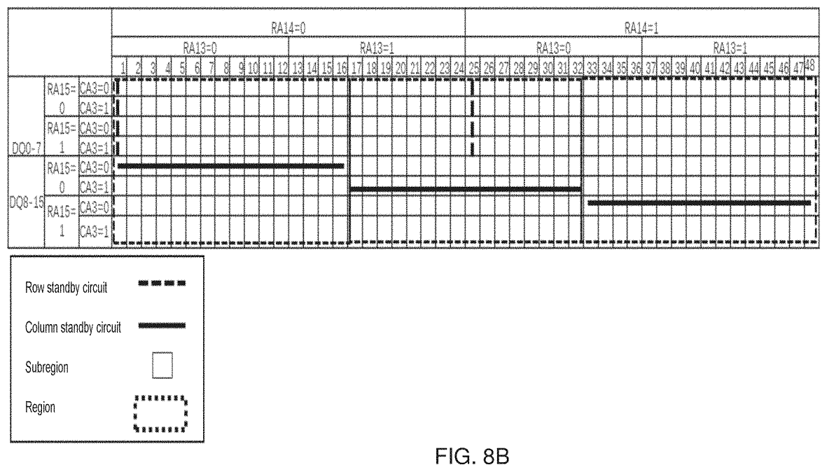

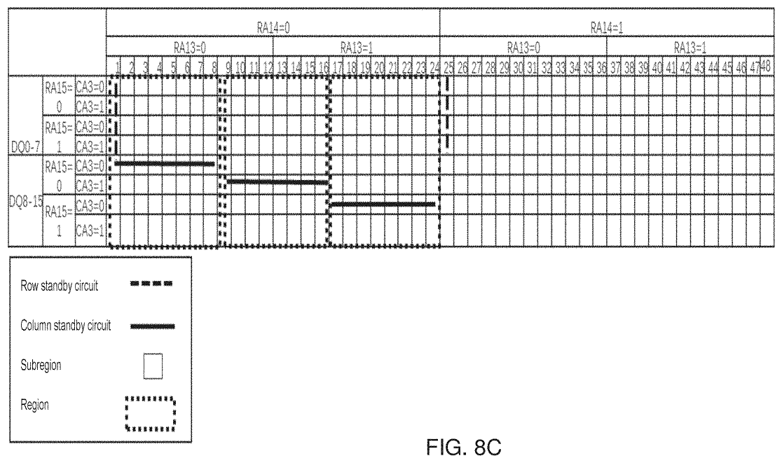

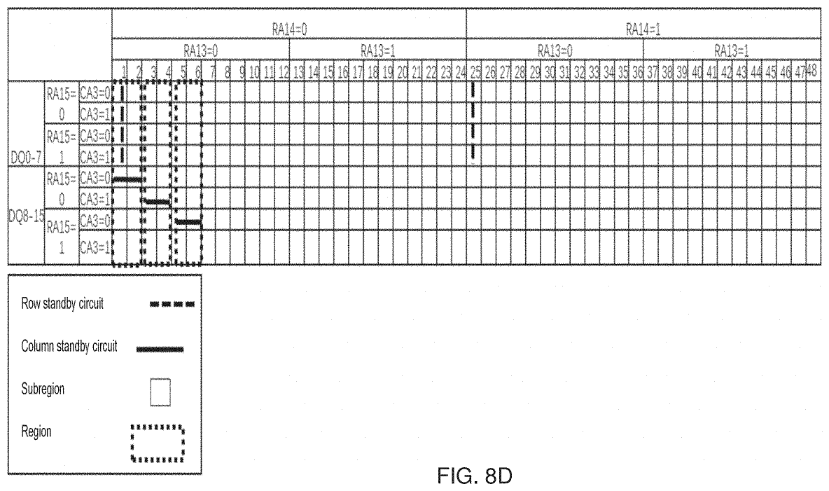

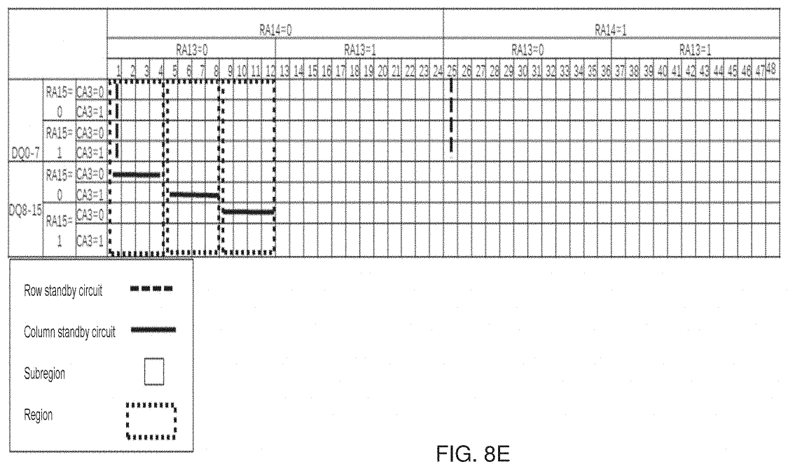

As an example, referring to FIG. 7, assuming that the simulation yield of the present RDC data does not meet the requirements, and the allocation and repair scheme of the designer for the row standby circuits keeps unchanged, there are the following five allocation and repair schemes shown in FIG. 8a, FIG. 8b, FIG. 8c, FIG. 8d and FIG. 8e for the column standby circuits. As shown in FIG. 7, the bank includes 128 allocable row standby circuits. The allocation and repair scheme for the row standby circuits includes: RA14/RA15 are repaired at the same time, DQ0-7 and DQ8-15 cannot be repaired at the same time, and RA=0 and RA=1 are repaired at the same time. The allocation and repair scheme for the column standby circuits includes: values in CA3 and RA15 cannot be repaired at the same time, and 8DQ are repaired at the same time. There are 192 regions, each of which includes 2 subregions and 3 allocable column standby circuits. Therefore, the bank includes 3*4*48=576 allocable column standby circuits. Referring to FIG. 8A, OPT1: the bank includes 128 allocable row standby circuits. The allocation and repair scheme for the row standby circuits includes: RA14/RA15 are repaired at the same time, DQ0-7 and DQ8-15 cannot be repaired at the same time, and RA=0 and RA=1 are repaired at the same time. The allocation and repair scheme for the column standby circuits includes: values in CA3 and RA15 are repaired at the same time, and 8DQ are repaired at the same time. There are 12 regions, each of which includes 32 subregions and 4 allocable column standby circuits. Therefore, the bank includes 12*4*12=576 allocable column standby circuits.

Referring to FIG. 8B, OPT2: the bank includes 128 allocable row standby circuits. The allocation and repair scheme for the row standby circuits includes: RA14/RA15 are repaired at the same time, DQ0-7 and DQ8-15 cannot be repaired at the same time, and RA=0 and RA=1 are repaired at the same time. The allocation and repair scheme for the column standby circuits includes: values in CA3 and RA15 are repaired at the same time, and 16DQ are repaired at the same time. There are 3 regions, each of which includes 128 subregions and 8 allocable column standby circuits. Therefore, the bank includes 24*8*3=576 allocable column standby circuits.

Referring to FIG. 8C, OPT3: unlike FIG. 8b, there are 6 regions, each of which includes 64 subregions and 8 allocable column standby circuits. Therefore, the bank includes 12*8*6=576 allocable column standby circuits.

Referring to FIG. 8D, OPT4: unlike FIG. 8b, there are 24 regions, each of which includes 16 subregions and 8 allocable column standby circuits. Therefore, the bank includes 3*8*24=576 allocable column standby circuits.

Referring to FIG. 8E, OPT5: unlike FIG. 8b, there are 3 regions, each of which includes 32 subregions and 8 allocable column standby circuits. Therefore, the bank includes 6*8*12=576 allocable column standby circuits.

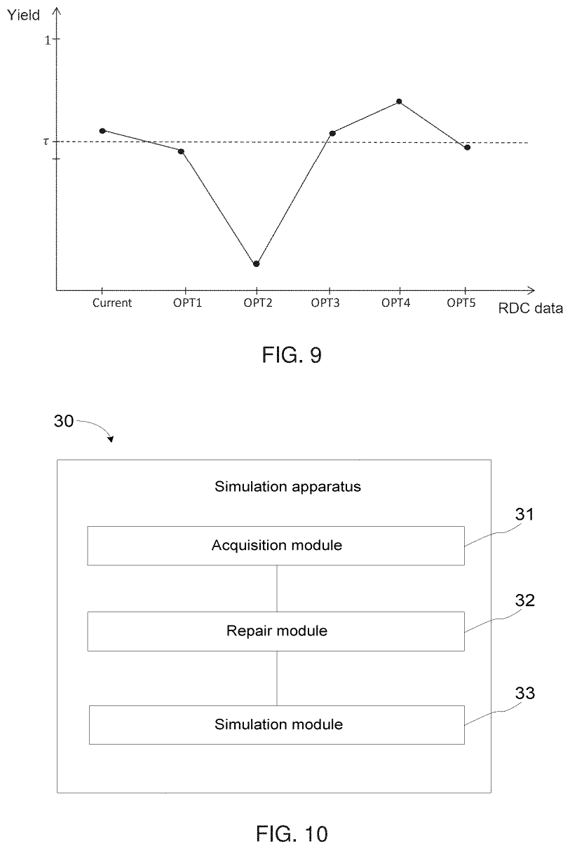

As an example, referring to FIG. 9, the simulation is performed according to the present RDC data (Current) and the schemes in FIG. 8a, FIG. 8b, FIG. 8c, FIG. 8d and FIG. 8e to obtain a yield chart shown in FIG. 9. In the transverse direction, there are options (different RDC data), including OPT1, OPT2, OPT3, OPT4 and OPT5. In the longitudinal direction, there are yields (simulation yields). A threshold τ is preset to select the RDC data with the yield meeting the requirements. The specific value of the τ may depend on the yield of the products. For example, τ>50%can be set to obtain the RDC data with the yield greater than 50%.

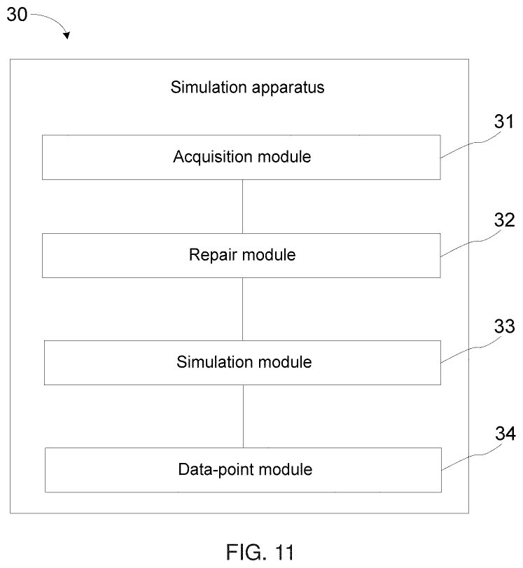

Referring to FIG. 10, an embodiment of the present application provides a simulation apparatus 30, including an acquisition module 31, a repair module 32 and a simulation module 33, where the acquisition module 31 is configured to acquire RDC data and historical test data of products, the historical test data including repair range information, subregion information and address information of failure cells, and the RDC data including repair schemes; the repair module 32 is configured to allocate the repair schemes to failure cells in the historical test data according to a preset RA, and acquire a corresponding simulation repair result; and the simulation module 33 is configured to obtain a yield of the products based on the simulation repair result and the historical test data.

As an example, referring also to FIG. 10, the acquisition module 31 further includes a duration acquisition module (not shown), configured to acquire a duration, the historical test data being test data in the duration. By obtaining the simulation yield of the semiconductor products with the present design according to historical test data of a previous adjacent design cycle to the present design cycle, the simulation apparatus is helpful for the designer to detect early defects in the design and improve the design, avoids the waste of production and test costs due to the defective design being put into production, and fully utilizes the historical test data to greatly shorten the design update cycle.

As an example, referring to FIG. 11, with simulation of chips as an example, the simulation apparatus 30 further includes: a data-point module 34, the data-point module 34 being configured to store a TCC, a TUCC and the simulation yield of the products, so as to obtain historical test data in a present design cycle.

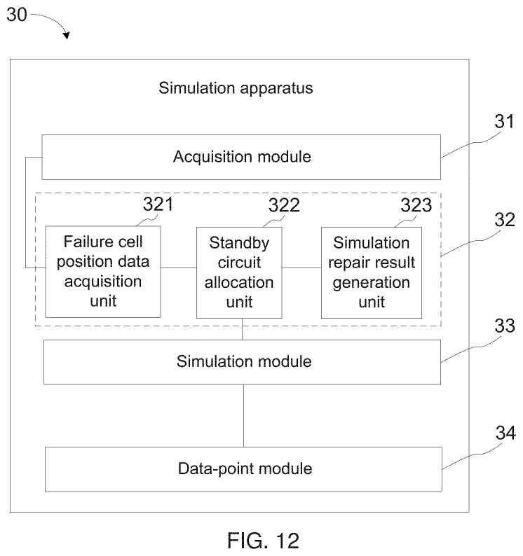

As an example, referring to FIG. 12, the repair schemes each include a count of allocable row standby circuits and corresponding position data as well as a count of allocable column standby circuits and corresponding position data in a preset subregion; and the repair module 32 includes a failure cell position data acquisition unit 321, a standby circuit allocation unit 322 and a simulation repair result generation unit 323, where the failure cell position data acquisition unit 321 is configured to acquire position data of the failure cells in the products; the standby circuit allocation unit 322 is configured to allocate row standby circuits and column standby circuits according to the position data of the failure cells and a repair rule; and the simulation repair result generation unit 323 is configured to acquire a count and position data of failure cells out of repair ranges 10 of allocated row standby circuits and allocated column standby circuits to generate the corresponding simulation repair result.

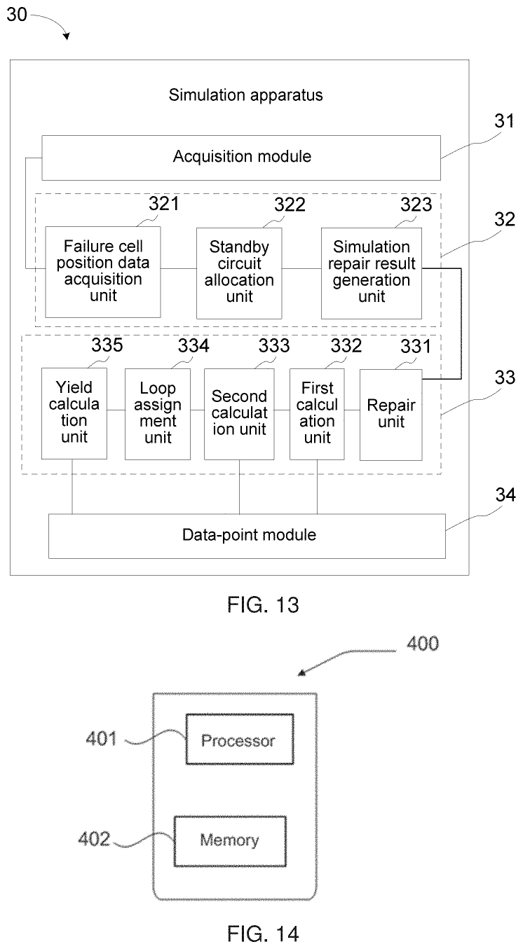

As an example, referring to FIG. 13, the simulation module 33 includes a repair unit 331, a first calculation unit 332, a second calculation unit 333, a loop assignment unit 334 and a yield calculation unit 335, where the repair unit 331 is configured to repair, based on test data of an ith set of chips in the historical test data and the RDC data, the ith set of chips to obtain a simulation repair result for the ith set of chips, the simulation repair result for the ith set of chips including an unrepairable chip count in the ith set of chips, and i having an initial value of 1 and being a positive integer; the first calculation unit 332 is configured to calculate a sum of a chip count in an (i−1)th set of chips and a chip count in the ith set of chips to obtain a TCC; the second calculation unit 333 is configured to calculate a sum of an unrepairable chip count in the (i−1)th set of chips and the unrepairable chip count in the ith set of chips to obtain a UTCC; the loop assignment unit 334 is configured to assign i+1 to i, and return to a step of performing simulation repair on the ith set of chips, based on test data of the ith set of chips in the historical test data and the RDC data, until an assigned i is greater than a chipset count in the historical test data; and the yield calculation unit 335 is configured to obtain the yield of the products based on the TCC and the TUCC.

As an example, the simulation of chip products is used as an example to exemplarily describe the implementation principles of the present application. A duration is acquired to obtain test data within the duration to serve as historical test data, the historical test data including repair range information, subregion information and address information of failure cells. RDC data, the historical test data and the duration of the products are obtained, the RDC data including repair schemes. The repair schemes are allocated to the failure cells in the historical test data according to a preset RA, position data of the failure cells in the products are acquired, row standby circuits and column standby circuits are allocated according to the position data of the failure cells and the repair rule, and a count and position data of failure cells out of repair ranges of allocated row standby circuits and allocated column standby circuits are acquired to generate a corresponding simulation repair result. The repair rule may include the rule of word line and the rule of bit line described above. Loop simulation is performed until all chipsets in the historical test data are traversed (Loop-MD), and the preset RA is executed to allocate the repair schemes to the failure cells in the historical test data. For example, based on test data of an ith set of chips in the historical test data and the RDC data, the ith set of chips are repaired to obtain a simulation repair result for the ith set of chips, the simulation repair result for the ith set of chips including an unrepairable chip count in the ith set of chips, and i having an initial value of 1 and being a positive integer. A sum of a chip count in an (i−1)th set of chips and a chip count in the ith set of chips is calculated to obtain a TCC. A sum of an unrepairable chip count in the (i−1)th set of chips and the unrepairable chip count in the ith set of chips is calculated to obtain a UTCC. i+1 is assigned to i, and a step of performing simulation repair on the ith set of chips, based on test data of the ith set of chips in the historical test data and the RDC data, is returned until an assigned i is greater than a chipset count in the historical test data. The yield of the products is obtained based on the TCC and the TUCC. When the loop simulation is performed and the preset RA is executed to allocate the repair schemes to the failure cells in the historical test data, the TCC++, the TUCC++, and the yield of the products are stored to a preset memory space (data_point). When a yield of the products is greater than or equal to a threshold, the products meet the requirements. Otherwise, if the yield of the products is less than the threshold, the RDC data may be changed, such that the execution main body of the simulation method, such as the computer, acquires updated RDC data, and obtains a yield of the products under new RDC data based on the updated RDC data and the historical test data. Further, based on yields of the products in various RDC data, RDC data meeting requirements in the various RDC data are obtained; or based on yields of the products in various RDC data and the sizes of the chips, RDC data meeting requirements in the various RDC data are obtained. Therefore, by obtaining the simulation yield of the semiconductor products with the present design before production of the semiconductor products, the simulation apparatus in the embodiment is helpful for the designer to detect early defects in the design and improve the design, avoids the waste of production and test costs due to the defective design being put into production, and fully utilizes the historical test data to greatly shorten the design update cycle.

An exemplary embodiment of the present disclosure provides an apparatus for testing semiconductor devices. Referring to FIG. 14, the apparatus for testing semiconductor devices 400 may be provided as a terminal device. The apparatus for testing semiconductor devices 400 may include a processor 401, and one or more processors may be set as required. The apparatus for testing semiconductor devices 400 may further include a memory 402 configured to store an executable instruction, such as an application program, of the processor 401. One or more memories may be set as required. The memory may store one or more application programs. The processor 401 is configured to execute the instruction to perform the foregoing method. Those of ordinary skill in the art may understand that all or some of the procedures in the methods of the foregoing embodiments may be implemented by a computer program instructing related hardware. The program may be stored in a non-volatile computer-readable storage medium. When the program is executed, the procedures in the embodiments of the foregoing methods may be performed. For any reference used for a memory, a storage, a database, or other media used in various embodiments provided in this application may include at least one of a non-volatile memory and a volatile memory. The non-volatile memory may include a read-only memory (ROM), a magnetic tape, a floppy disk, a flash or an optical memory. The volatile memory may include a random access memory (RAM) or an external cache memory. By way of illustration and not limitation, RAM is available in many forms such as static random access memory (SRAM) or dynamic random access memory (DRAM). In addition, as is well known to persons of ordinary skill in the art, the communication media usually contain computer-readable instructions, data structures, program modules, or other data in modulated data signals such as carrier waves or other transmission mechanisms, and may include any information transfer medium.

In an exemplary embodiment, a non-transitory computer-readable storage medium including instructions is provided. Referring to FIG. 14, for example, the non-transitory computer-readable storage medium may be the memory 402 including instructions. The foregoing instructions may be executed by the processor 401 of the apparatus for testing semiconductor devices 400 to complete the foregoing method. For example, the non-transitory computer-readable storage medium may be a ROM, a RAM, a CD-ROM, a magnetic tape, a floppy disk, an optical data storage device, or the like.

The present disclosure is described with reference to the flowcharts and/or block diagrams of the method, the apparatus (device), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, such that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, such that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, such that a series of operations and steps are performed on the computer or the another programmable device, thereby generating computer-implemented processing. Therefore, the instructions executed on the computer or the another programmable device provide steps for implementing a function specified in one or more processes in the flowcharts and/or in one or more blocks in the block diagrams.

The technical features of the above embodiments can be employed in arbitrary combinations. To provide a concise description of these embodiments, all possible combinations of all technical features of the embodiments may not be described; however, these combinations of technical features should be construed as disclosed in the description as long as no contradiction occurs.

Only several embodiments of the present application are described specifically in detail above, but they should not therefore be construed as limiting the scope of the present application. It should be noted that those of ordinary skill in the art can further make variations and improvements without departing from the concept of the present application. These variations and improvements all fall within the protection scope of the present application. Therefore, the protection scope of the present application should be subject to the protection scope defined by the appended claims.

1. A simulation method, comprising:
acquiring redundancy design configuration (RDC) data and historical test data of products, the RDC data comprising repair schemes;
allocating the repair schemes to failure cells in the historical test data according to a preset repair algorithm (RA), and acquiring a corresponding simulation repair result; and
obtaining a yield of the products based on the simulation repair result and the historical test data.

2. The simulation method according to claim 1, before the obtaining a yield of the products based on the simulation repair result and the historical test data, the method further comprises:
acquiring a duration, the historical test data being test data in the duration.

3. The simulation method according to claim 1, wherein the historical test data comprises repair range information, subregion information and address information of the failure cells.

4. The simulation method according to claim 1, wherein the products comprise chips, and the method further comprises:
storing a TCC, a TUCC and a simulation yield of the products.

5. The simulation method according to claim 1, wherein the repair schemes each comprise a count of allocable row standby circuits and corresponding position data as well as a count of allocable column standby circuits and corresponding position data in a preset subregion; and the preset RA comprises a repair rule; and
the allocating the repair schemes to failure cells in the historical test data according to a preset RA, and acquiring a corresponding simulation repair result comprises:
acquiring position data of the failure cells in the products;
allocating row standby circuits and column standby circuits according to the position data of the failure cells and the repair rule; and
acquiring a count and position data of failure cells out of repair ranges of allocated row standby circuits and allocated column standby circuits to generate the corresponding simulation repair result.

6. The simulation method according to claim 5, wherein the obtaining a yield of the products based on the simulation repair result and the historical test data comprises:
repairing, based on test data of an ith set of chips in the historical test data and the RDC data, the ith set of chips to obtain a simulation repair result for the ith set of chips, the simulation repair result for the ith set of chips comprising an unrepairable chip count in the ith set of chips, and i having an initial value of 1 and being a positive integer;
calculating a sum of a chip count in an (i−1)th set of chips and a chip count in the ith set of chips to obtain a TCC;
calculating a sum of an unrepairable chip count in the (i−1)th set of chips and the unrepairable chip count in the ith set of chips to obtain a TUCC;
assigning i+1 to i, and returning to the step of performing simulation repair on the ith set of chips, based on test data of the ith set of chips in the historical test data and the RDC data, until an assigned i is greater than a chipset count in the historical test data; and
obtaining the yield of the products based on the TCC and the TUCC.

7. The simulation method according to claim 6, the method further comprises:
determining whether simulation is ended; and
acquiring, when no, updated RDC data, and obtaining a yield of the products under new RDC data based on the updated RDC data and the historical test data.

8. The simulation method according to claim 7, wherein the simulation repair result for the ith set of chips further comprises sizes of chips in the ith set of chips, and the method further comprises:
obtaining, based on yields of the products in various RDC data, RDC data meeting requirements in the various RDC data; or
obtaining, based on yields of the products in various RDC data and the sizes of the chips, RDC data meeting requirements in the various RDC data.

9. The simulation method according to claim 8, wherein when the yield of the products is greater than or equal to a threshold, the products meet the requirements.

10. The simulation method according to claim 5, wherein
an extension direction of each of the row standby circuits is consistent with that of a word line; and
an extension direction of each of the column standby circuits is consistent with that of a bit line.

11. A simulation apparatus, comprising:
one or more processors; and
a storage apparatus, configured to store one or more programs, wherein the one or more programs, when executed by the one or more processors, cause the one or more processors to execute operations of:
acquiring redundancy design configuration (RDC) data and historical test data of products, the RDC data comprising repair schemes;
allocating the repair schemes to failure cells in the historical test data according to a preset RA, and acquiring a corresponding simulation repair result; and
obtaining a yield of the products based on the simulation repair result and the historical test data.

12. The simulation apparatus according to claim 11, wherein the one or more programs cause the one or more processors to execute operations of:
acquiring a duration, the historical test data being test data in the duration.

13. The simulation apparatus according to claim 11, wherein the historical test data comprises repair range information, subregion information and address information of the failure cells.

14. The simulation apparatus according to claim 11, wherein the products comprise chips, and the one or more programs cause the one or more processors to execute operations of:
storing a TCC, a TUCC and a simulation yield of the products.

15. The simulation apparatus according to claim 11, wherein the repair schemes each comprise a count of allocable row standby circuits and corresponding position data as well as a count of allocable column standby circuits and corresponding position data in a preset subregion; and the one or more programs cause the one or more processors to execute operations of:
acquiring position data of the failure cells in the products;
allocating row standby circuits and column standby circuits according to the position data of the failure cells and a repair rule; and
acquiring a count and position data of failure cells out of repair ranges of allocated row standby circuits and allocated column standby circuits to generate the corresponding simulation repair result.

16. The simulation apparatus according to claim 15, wherein the one or more programs cause the one or more processors to execute operations of:
repairing, based on test data of an ith set of chips in the historical test data and the RDC data, the ith set of chips to obtain a simulation repair result for the ith set of chips, the simulation repair result for the ith set of chips comprising an unrepairable chip count in the ith set of chips, and i having an initial value of 1 and being a positive integer;
calculating a sum of a chip count in an (i−1)th set of chips and a chip count in the ith set of chips to obtain a TCC;
calculating a sum of an unrepairable chip count in the (i−1)th set of chips and the unrepairable chip count in the ith set of chips to obtain a TUCC;
assigning i+1 to i, and returning to a step of performing simulation repair on the ith set of chips, based on test data of the ith set of chips in the historical test data and the RDC data, until an assigned i is greater than a chipset count in the historical test data; and
obtaining the yield of the products based on the TCC and the TUCC.

17. A computer-readable storage medium, wherein the computer-readable storage medium stores a computer program, and the computer program is executed by a processor to implement steps of the method according to claim 1.
